(19) United States
(12) Patent Application Publication
(10) Pub. No.: US 2003/0121842 A1
(43) Pub. Date: Jul. 3, 2003

(54) Encapsulated filter unit, system and method for filtering fluids

(75) Inventor: Johannes Adrianus Thomassen, Moulecilo (SB)

Correspondence Address: STEINBERG & RASKIN, P.C., 1140 AVENUE OF THE AMERICAS, 15th FLOOR, NEW YORK, NY, 10036-5803, US

(73) Assignee: MEMBRANE CONCEPTS, S.L.

(21) Appl. No.: 10/261,274

(22) Filed: Sep. 30, 2002

Related U.S. Application Data
(63) Continuation-in-part of application No. 09/994,488, filed on Nov. 24, 2001.
Application No. 09/994,488 is a continuation-in-part of application No. 09/934,023, filed on Aug. 21, 2001.
Application No. 09/994,488 is a continuation-in-part of application No. 09/991,567, filed on Nov. 23, 2001.

(51) Int. Cl. B01D 29/50

(52) U.S. Cl. 210/323.2; 210/232; 210/330; 210/331

(57) ABSTRACT

This disclosure relates to an encapsulated filter unit, a system and a method of filtering fluids. The filter unit has a generally cylindrically shaped, membrane filter body with a plurality of filter elements. An anti-telescoping connecting element at each element end joins the filter elements end to end and coaxially to one another. The joined elements are housed by a relatively rigid outer shell. A filter head at each end of the unit enables connection of the units to one another while capping the unit ends. The shell comprises a barrier tube encased by a first helically wrapped layer of a first material, and each filter head includes an adapter encapsulated by a first hoop wrapped layer of a second material. The respective layers abut one another such that a continuous, generally uniform, relatively rigid composite outer wrapped layer is formed for effectively encasing the unit. The adapter has a slot located on an interior peripheral surface for receiving a sealing member. Upon engagement of the sealing member with the slot on one side and the barrier tube, or alternatively the connecting element, on the other side, a flexible seal between the adapter and barrier tube (or connecting element) is effected during filter unit operation. A second hoop wrapped layer of a third material is formed about both the first helically wrapped layer and the first hoop wrapped layer for effectively and aesthetically encapsulating the unit.

This application is a continuation-in-part of co-pending application Ser. No. 09/994,488, filed on Nov. 24, 2001, which is a continuation-in-part of co-pending application Ser. No. 09/934,023, filed on Aug. 21, 2001, and of application Ser. No. 09/991,567, filed Nov. 23, 2001.

### BACKGROUND OF THE INVENTION

The present invention relates generally to systems for physical and chemical separation and, more particularly, to an assembly, a system and a method of filtering fluids or the like.

Conventional fluid filtration systems accomplish physical separation, for example, by passing a fluid through a series of filter units. The fluid passes from one unit to another until it exits a final or end unit of the system, i.e., in a filtered state. Each unit typically includes at least one filter element, each with a body formed, for instance, in a cylindrical shape, by a spiral or microtube membrane. A shell or casing about the membrane maintains the filter body in its cylindrical shape at a generally uniform diameter throughout the length thereof. Two or more filter elements are then housed in a relatively rigid tube and joined end to end to form a filter unit. A cap or filter head is secured to the unit's intake and outlet ends, respectively, the filter head being joined to the tube interior by an annular gasket inside the mouth of the tube.

While found generally effective for filtration, these conventional arrangements also facilitate gradual build up of deposits and impurities on the filter elements as well as bacterial growth. Since this accumulation is generally irreversible, the individual filter elements and, eventually, the entire system are rendered ineffective. In addition, during normal use the pressure inside a particular unit often becomes high, causing the rigid tube housing the filter element to expand slightly. This, in turn, allows fluid to leak between the filter heads, the ring gasket and the tube. Moreover, because the filter element is manufactured separately, is can become difficult to fit the filter element precisely into the tube. Accordingly, it is often not possible to consistently effect a fluid tight seal with the tube. This imperfect fit of the filter element with the tube will lead to fluid leakage and other malfunctioning of the filter unit. When a filter unit consists of two or more such elements, any malfunction common to each element becomes magnified. Hence, a single defective filter unit can lead to degradation of the entire filtering operation.

A high performance filtration unit and system are, therefore, desired that not only provide improved performance and efficiency, but also long lasting, maintenance free filter units.

### SUMMARY OF THE INVENTION

According to one aspect of the present invention, there is provided a system for filtering fluids which comprises a plurality of encapsulated filter units. Each unit has a generally cylindrically shaped, membrane filter body with a plurality of filter elements. An anti-telescoping connector element is provided at each element end for joining the filter elements end to end and coaxially to one another. A relatively rigid outer shell houses the joined elements. A filter head located at each end enables connection of the units to one another while capping the unit ends. The shell comprises a barrier tube encased by a helically wrapped layer of a first material. In addition, each filter head includes an adapter encapsulated by a hoop wrapped layer of second material. The respective layers abut one another such that a continuous, generally uniform, relatively rigid composite outer wrapped layer is formed for effectively encasing the unit. A slot is located on an interior peripheral surface of the adapter for receiving a sealing member. Upon engagement of the sealing member with the slot on one side and the barrier tube on the other side, a flexible seal between the adapter and barrier tube is effected during filter unit operation.

In accordance with another aspect of the present invention is a system for filtering fluids, which comprises a plurality of encapsulated filter units, each unit having a generally cylindrically shaped, membrane filter body with a plurality of filter elements. An anti-telescoping connector element at each element end joins the filter elements end to end and coaxially to one another. A relatively rigid outer shell houses the joined elements. A filter head is provided at each end of the unit for enabling connection of the units to one another while capping the unit ends. The shell comprises a barrier tube encased by a helically wrapped layer of a first composite material. Each filter head includes an adapter encapsulated by a hoop wrapped layer of second composite material. The respective layers abut one another such that a continuous, generally uniform, relatively rigid composite outer wrapped layer is formed for effectively encasing the unit. A slot is located on an interior peripheral surface of the adapter for receiving a sealing member. Upon engagement of the sealing member with the slot on one side and the connecting element on the other side, a flexible seal between the adapter and connector element is effected during filter unit operation.

According to a further aspect of the present invention is a system for filtering fluids, which also comprises a plurality of filter units, each unit including a generally cylindrically shaped, membrane filter body comprising a plurality of filter elements. Connecting elements are provided for joining the filter elements end to end and coaxially to one another. Also provided is a relatively rigid barrier tube for housing the joined elements. The elements have peripheral portions configured for snug engagement within the outer shell. An adapter is engaged with each end of the barrier tube for joining the units to one another and capping the unit ends. A slot located on an interior peripheral surface of the adapter receives a sealing member. Upon engagement of the sealing member with the slot on one side and the barrier tube on the other side, a flexible seal between the adapter and the barrier tube is effected during filter unit operation. The barrier tube is covered substantially over its length by a helically wrapped layer and the adapter is covered substantially over its length by a first hoop wrapped layer. The respective layers abut one another such that a continuous, generally uniform, relatively rigid composite outer first wrapped layer is formed. A second hoop wrapped layer of a third material formed, in turn, about the first wrapped layer effectively and aesthetically encases the unit.

According to a further aspect of the present invention is a system for filtering fluids, which also comprises a plurality of filter units. Each unit has a generally cylindrically shaped, membrane filter body comprising a plurality of filter elements. Connecting elements join the filter elements end to end and coaxially to one another. A relatively rigid barrier tube houses the joined elements, the elements having peripheral portions configured for snug engagement within the outer shell. An adapter is engaged with each end of the barrier tube for joining the units to one another and capping the unit ends. A slot located on an interior peripheral surface of the adapter receives a sealing member, whereupon engagement of the sealing member with the slot on one side and the connector element on the other side, a flexible seal between the adapter and the connector element is effected during filter unit operation. The barrier tube is covered substantially over its length by a helically wrapped layer and the adapter is covered substantially over its length by a first hoop wrapped layer. The respective layers abut one another such that a continuous, generally uniform, relatively rigid composite outer first wrapped layer is formed. Finally, a second hoop wrapped layer formed, in turn, about the first wrapped layer effectively and aesthetically encases the unit.

In accordance with still another aspect of the present invention is an encapsulated filter unit. The unit has a generally cylindrically shaped, membrane filter body with a plurality of filter elements. An anti-telescoping connector element is provided at each element end for joining the filter elements end to end and coaxially to one another. A relatively rigid outer shell houses the joined elements. A filter head located at each end enables connection of the units to one another while capping the unit ends. The shell comprises a barrier tube encased by a helically wrapped layer of a first material. In addition, each filter head includes an adapter encapsulated by a hoop wrapped layer of second material. The respective layers abut one another such that a continuous, generally uniform, relatively rigid composite outer wrapped layer is formed for effectively encasing the unit. A slot is located on an interior peripheral surface of the adapter for receiving a sealing member. Upon engagement of the sealing member with the slot on one side and the barrier tube on the other side, a flexible seal between the adapter and barrier tube is effected during filter unit operation.

According to yet another aspect of the present invention is an encapsulated filter unit having a generally cylindrically shaped, membrane filter body with a plurality of filter elements. An anti-telescoping connector element at each element end joins the filter elements end to end and coaxially to one another. A relatively rigid outer shell houses the joined elements. A filter head is provided at each end of the unit for enabling connection of the units to one another while capping the unit ends. The shell comprises a barrier tube encased by a helically wrapped layer of a first composite material. Each filter head includes an adapter encapsulated by a hoop wrapped layer of a second composite material. The respective layers abut one another such that a continuous, generally uniform, relatively rigid composite outer wrapped layer is formed for effectively encasing the unit. A slot is located on an interior peripheral surface of the adapter for receiving a sealing member. Upon engagement of the sealing member with the slot on one side and the connecting element on the other side, a flexible seal between the adapter and connector element is effected during filter unit operation.

In accordance with yet a further aspect of the present invention is a filter unit including a generally cylindrically shaped, membrane filter body with a plurality of filter elements. Connecting elements are provided for joining the filter elements end to end and coaxially to one another. Also provided is a relatively rigid barrier tube for housing the joined elements. The elements have peripheral portions configured for snug engagement within the outer shell. An adapter is engaged with each end of the barrier tube for joining the units to one another and capping the unit ends. A slot located on an interior peripheral surface of the adapter receives a sealing member. Upon engagement of the sealing member with the slot on one side and the barrier tube on the other side, a flexible seal between the adapter and the barrier tube is effected during filter unit operation. The barrier tube is covered substantially over its length by a helically wrapped layer and the adapter is covered substantially over its length by a first hoop wrapped layer. The respective layers abut one another such that a continuous, generally uniform, relatively rigid composite outer first wrapped layer is formed. A second hoop wrapped layer of a third material formed, in turn, about the first wrapped layer effectively and aesthetically encases the unit.

According to still another aspect of the present invention is a filter unit which also includes a generally cylindrically shaped, membrane filter body comprising a plurality of filter elements. Connecting elements join the filter elements end to end and coaxially to one another. A relatively rigid barrier tube houses the joined elements, the elements having peripheral portions configured for snug engagement within the outer shell. An adapter is engaged with each end of the barrier tube for joining the units to one another and capping the unit ends. A slot located on an interior peripheral surface of the adapter receives a sealing member, whereupon engagement of the sealing member with the slot on one side and the connector element on the other side, a flexible seal between the adapter and the connector element is effected during filter unit operation. The barrier tube is covered substantially over its length by a helically wrapped layer and the adapter is covered substantially over its length by a first hoop wrapped layer. The respective layers abut one another such that a continuous, generally uniform, relatively rigid composite outer first wrapped layer. Finally, a second hoop wrapped layer is formed about the first wrapped layer for effectively and aesthetically encasing the unit.

A further aspect of the present invention relates to a method of forming an encapsulated filtration unit. The method comprises the step of initially finishing a trimmed membrane element, the element having connector elements at each end. The trimmed membrane element is then located in a barrier tube. An adapter and a permeate interconnector are inserted into at least one end of the barrier tube, and a mounting sleeve is inserted into at least one of the adapters. Next, the barrier tube is helically wrapped to a first selected thickness so as to encapsulate the tube. Each adapter is, in turn, hoop wrapped to a second selected thickness so as to encase the adapter. Finally, the mounting sleeves are cut off so as to form an encapsulated unit of a selected length.

Yet another aspect of the invention is a method of forming an encapsulated filtration unit. First, a trimmed membrane element is finished and located in a barrier tube. An adapter and a permeate interconnector are then inserted into at least one end of the barrier tube, and a mounting sleeve is inserted into at least one of the adapters. Next, the barrier tube is helically wrapped to a first selected thickness so as to encapsulate the tube. Each adapter is, in turn, hoop wrapped to a second selected thickness so as to encase the adapter. Thereafter, the encapsulated barrier tube and the encased adapter are hoop wrapped so as to effectively and aesthetically encase the unit. Finally, the mounting sleeves are cut off so as to form an encapsulated unit of a selected length.

In accordance with still a further aspect of the present invention is a method for filtration of a fluid. The method comprises the steps of directing a fluid flow in a first direction, the fluid passing through a plurality of encapsulated filter units arranged in a generally parallel fashion relative to one another. Each unit has a series of membrane filter elements linked by connecting elements and adapters. The fluid flow in the first direction is then ceased. Finally, the fluid flow is directed in a direction opposite to that of the first direction, the fluid passing back through at least one of the plurality of encapsulated filter units so as to prevent bacterial growth as well as the accumulation of waste deposits and impurities on the filter assemblies.

According to another aspect of the present invention, a method is provided for re-circulation filtration. Initially, a plurality of encapsulated filter units are arranged in parallel for receiving a flow of fluid. Next, a fluid flow is initiated in a first direction so as to direct the fluid through at least one of the filter units. Last, the fluid flow is directed in a reverse direction, back through the at least one filter unit so as to prevent bacterial growth as well as the accumulation of waste deposits and impurities on the filter assemblies.

Yet a further aspect of the present invention relates to a method for re-circulation filtration and regulated flow mixing through a filter system. First, a plurality of encapsulated filter units is arranged in parallel to form a filter system for receiving a flow of fluid, each unit including a series of filter elements. Next, a fluid flow is directed in a first direction so as to direct the fluid through at least one of the filter units. Valves are then positioned at selected points of the filter units to allow introduction and mixing of fluid flow supplied from several different entry points, and thereby allow a user to adjust the filter system for optimum balance of fluid flow.

Accordingly, it is an object of the present invention to provide a high performance filtration system with filter elements that are long lasting and maintenance free.

Another object of the present invention is to provide a filtration system with leakproof connections between filter components.

A further object of the present invention is to provide a novel filter unit construction for added durability, leakproof operation and more effective filtration.

Yet another object of the present invention is to provide an improved filtration system that allows ready removal of filter components for maintenance or replacement.

Still another object of the present invention is to provide an improved filtration system comprising a plurality of filter units adapted for arrangement in series and/or parallel.

Still a further object of the present invention is to provide a filtration system comprising a plurality of filter units with leakproof adapter connections between the units.

Yet a further object of the present invention is to provide an improved filter arrangement that allows user-selected, custom assembly of a filtration plant, simply, economically and for optimum performance.

Another object of the present invention is to provide a filtration unit that has a relatively low manufacturing cost.

A further object of the present invention is to provide an improved efficiency, membrane filter comprising two or more filter elements with corresponding connecting elements between them and adapters on each end, the periphery of the adapter fitting snugly within an outer shell so as to form a fluid tight seal.

Yet another object of the present invention is to provide a filtration system that minimizes bacterial growth on filter elements as well as gradual build up of deposits and impurities.

Still another object of the present invention is to provide a membrane element filtration unit having increased efficiency.

Another object of the present invention is to provide enhanced fluid purification such as during desalinization or the like.

Yet another object of the present invention is to provide a filtration system that utilizes reverse direction flow filtration in combination with flow mixture regulation for optimum cleansing of a fluid.

A further object of the present invention is to provide a simple, economical and reliable filtration system with filter components that may be connected directly to one another.

Yet a further object of the p resent invention is to provide a filtration system that is practical, effective and economical.

The invention will now be further described by reference to the following drawings which are not intended to limit the accompanying claims.

### BRIEF DESCRIPTION OF THE DRAWINGS

FIG. 1 shows a fluid filtration system including a plurality of encapsulated filter units, according to one aspect of the present invention;

FIG. 2 is an exploded view of a trimmed membrane element with adapters for an encapsulated filter unit, in accordance with the present invention;

FIG. 3 is a side view of an encapsulated filter unit showing interior portions of the unit in phantom, including adapters, connecting elements, filter elements, and flexible seals, according to one aspect of the present invention;

FIG. 4 is an enlarged view of the encapsulated filter unit of FIG. 3 taken along section AA;

FIG. 5 is a cross sectional view of a filter unit including an adapter, connecting element, filter element, and flexible seal, according to one aspect of the present invention;

FIG. 6 is a cross sectional view of a filter unit including an adapter, connecting element, filter element, and flexible seal, according to another aspect of the present invention;

FIG. 7 is a sectional view of the encapsulated filter unit of FIG. 3 showing a helically wrapped layer, a first hoop wrapped layer, a second hoop wrapped layer, and adapter portions in phantom;

FIG. 8 is an enlarged view of the encapsulated filter unit of FIG. 7 taken along section B-B;

FIG. 9 is a perspective view of the encapsulated filter unit shown in FIG. 7;

FIG. 10 is a perspective view of an encapsulated filter unit, according to one aspect of the present invention;

FIG. 11 is an exploded perspective view of the encapsulated filter unit of FIG. 10 without the first helically wrapped layer, first hoop wrapped layer and second hoop wrapped layer;

FIG. 12 is an assembled perspective view of the encapsulated filter unit of FIG. 11 with the mounting sleeves show in exploded view;

FIG. 13 is an open side view of the encapsulated filter unit of FIG. 12 showing interior components of the unit including a barrier tube, filter elements and permeate interconnectors;

FIG. 14 is a side view of the encapsulated filter unit of FIG. 8; and

FIG. 15 is a flow diagram showing a method of assembling an encapsulated filter unit, according to one aspect of the present invention.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

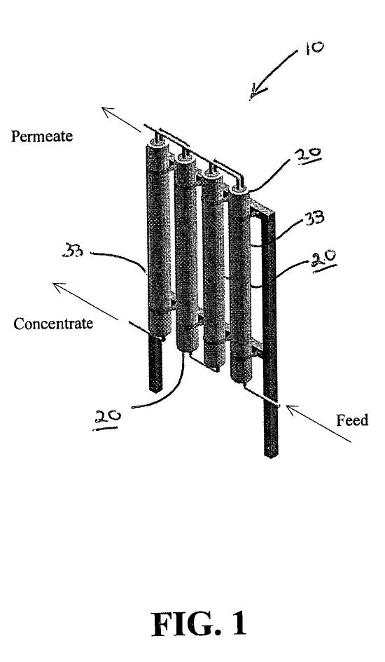

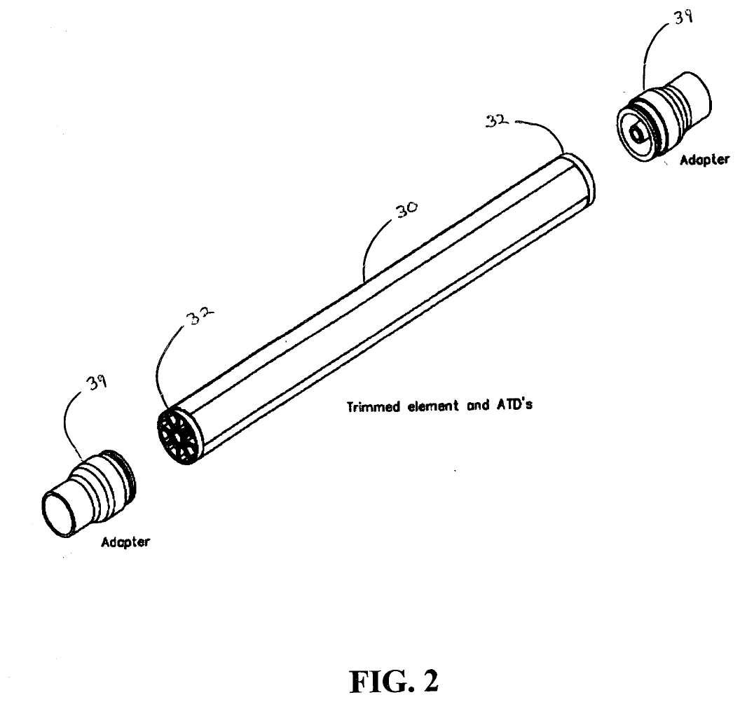

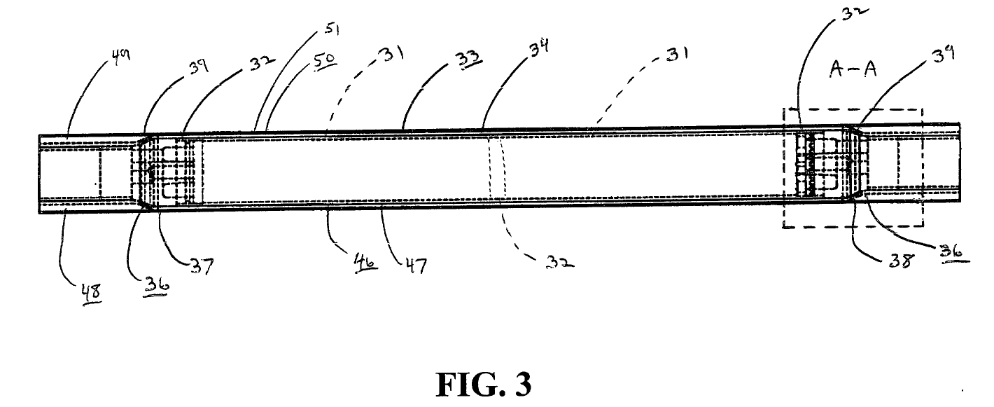

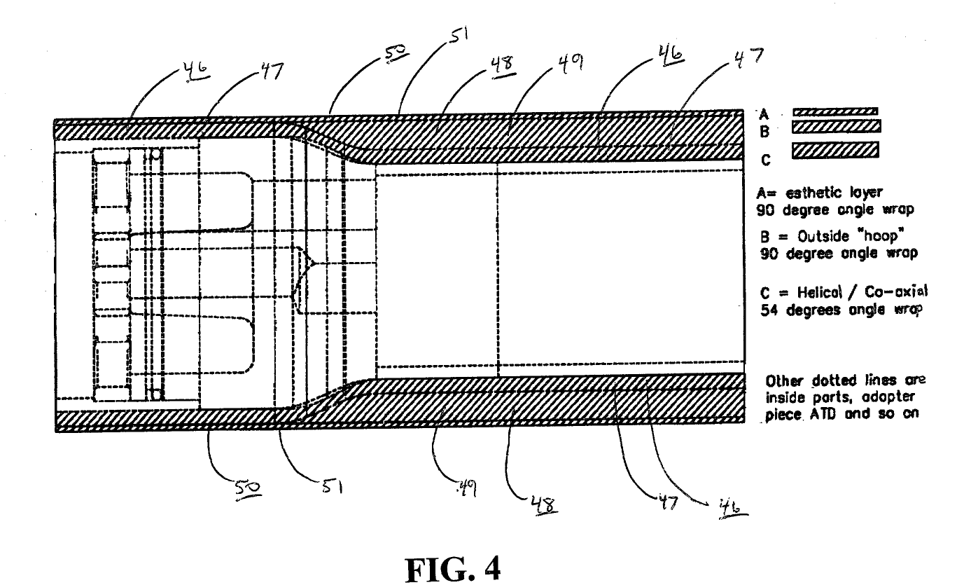

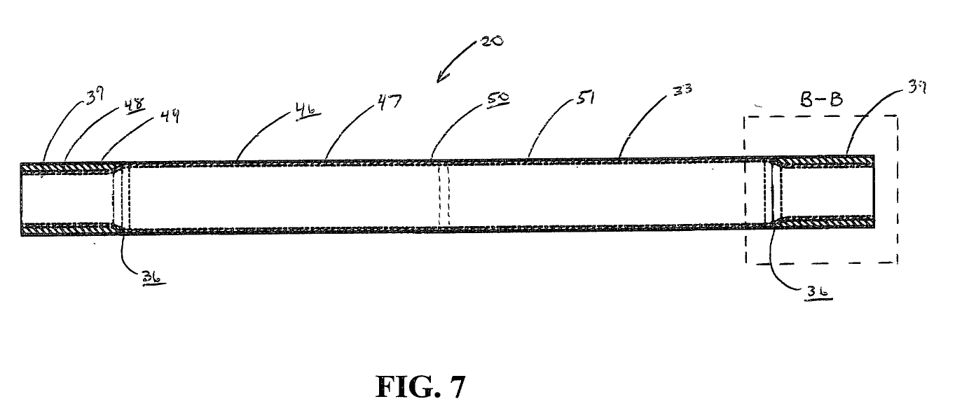

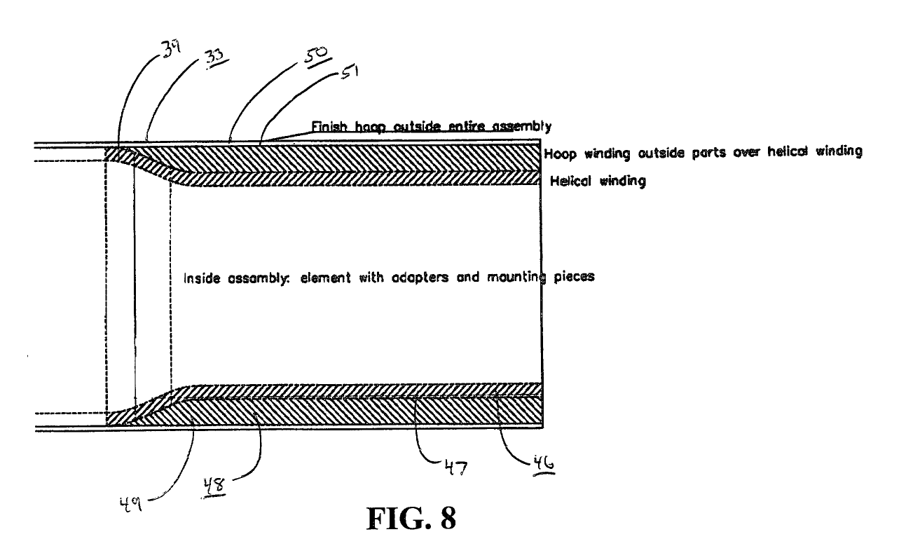

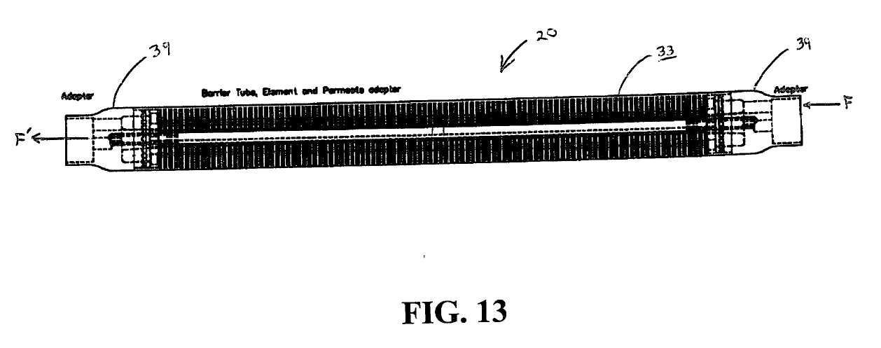

Referring now to the drawings and more particularly to FIGS. 1-15, there is shown generally a specific, illustrative system 10 for filtering fluids according to various aspects of the present invention. As shown in FIG. 1, the system comprises a plurality of filter units 20, each unit having a membrane filter body 30, such as a conventional spiral membrane or microtube membrane, with a series of filter elements 31 (See FIGS. 2 and 13). An anti-telescoping device (ATD) such as interconnecting members or connecting elements 32 are provided for joining the filter elements end to end and coaxially to one another, as best seen in FIGS. 3 and 4. The joined elements are desirably housed within an outer shell 33. In one embodiment, the outer shell comprises a relatively rigid barrier tube 34. The elements preferably have peripheral portions 35 figured for snug engagement within the barrier tube. An objective of connecting elements 32 is to prevent telescoping or other unraveling (axially or laterally) of a spirally wound membrane.

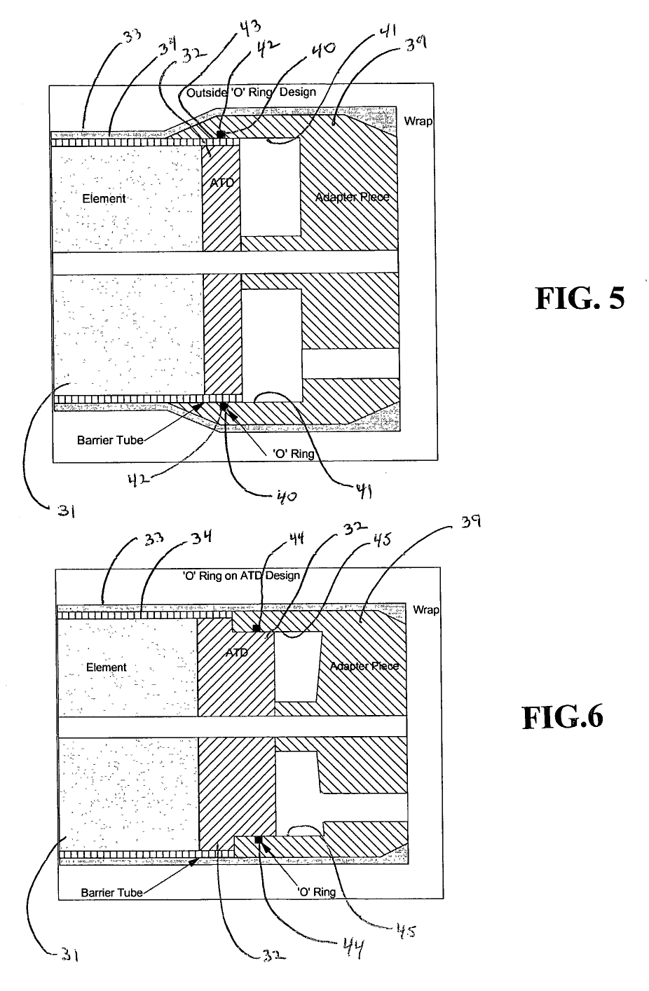

Filter heads or members 36 are provided at opposing ends 37, 38 of each unit for enabling connection of the units to one another and end to end, while capping the unit ends. Each member includes, or alternatively is characterized by, an adapter 39 configured for engagement radially with an end of the barrier tube so as to join the units to one another and, more or less concurrently, cap the unit ends. As shown in FIG. 5, a slot 40 is located on an interior peripheral surface 41 of the adapter, e.g., adjacent to and outside of the barrier tube, for receiving a sealing member 42 such as an O-ring. Upon its placement in the slot, the O-ring preferably rises at least slightly from a slot edge 43. In this manner, upon engagement of the sealing member with the slot on one side and the barrier tube on the other side, a flexible seal between the adapter and the barrier tube is effected during filter unit operation. This sealing arrangement has been found particularly beneficial in providing flexibility upon lateral expansion of the element and adapter assembly under pressure and, thereby, ensuring a continuous seal.

In an alternative embodiment, as shown in FIG. 6, or concurrently therewith, the adapter is configured for axial engagement with the barrier tube. In this connection, a slot 44 is located on an interior peripheral surface 45 of the adapter, e.g., preferably in proximity to the connecting element, for receiving the sealing member. Accordingly, upon engagement of the sealing member with the slot on one side and the connecting element on the other side, a flexible seal between the adapter and connector element is effected during filter unit operation.

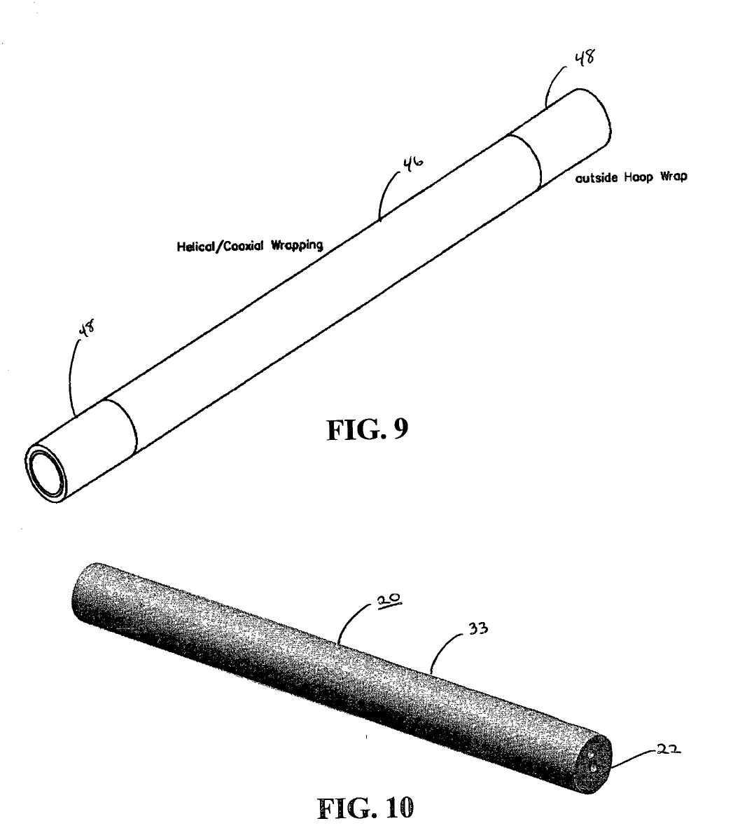

As illustrated in FIGS. 3-4 and 7-8, the barrier tube is preferably encased by a coaxially or helically wrapped layer 46 of a first selected material 47, e.g., desirably a composite of filaments fibers such as glass fiber, carbon, acrylic or the like, and/or a glass fiber surrounded by a molded layer of resin, or the like. Similarly, it is desired that each adapter be encapsulated by a hoop wrapped layer 48 of a second selected material 49, e.g., preferably also a composite of filaments fibers such as glass fiber, carbon, acrylic or the like, and/or a glass fiber surrounded by a molded layer of resin, or the like. As best seen in FIG. 9, the respective layers 46, 48 are desirably arranged and constructed so as to abut one another, i.e., axially, such that a continuous, generally uniform, relatively rigid composite outer wrapped layer 49 is formed for effectively encasing or substantially complete encapsulation of the unit. This arrangement has been found advantageous in providing a leakproof seal over a broad range of operating conditions and pressures. It also provides simplicity of assembly and manufacture, as well as lower cost.

Although the present invention has been shown and described utilizing an O-ring as the sealing member so as to provide a flexible seal, it will be understood that any flexible seal that ensures a watertight connection may be utilized, within the spirit and scope of the present invention. Suitable sealing arrangements include, but are not limited to, lip-seals, flat or rectangular seals, thin-wall welded plastic connections, shrinkwrap welded connections, welded foils, composite material seals, or like methods of sealing by way of welding onto both surfaces. Notably, in the case of a welded shrinkwrap, welded foil or composite material, the barrier itself is considered to be the flexible seal construction.

According to another embodiment, shown concurrently with the foregoing, the composite outer wrapped layer is wrapped or covered substantially, in whole or in part, by a second hoop wrapped layer 50 of a third selected material 51. Suitable materials include, but are not limited to, a composite of filaments fibers such as glass fiber, carbon, acrylic or the like, and/or a glass fiber surrounded by a molded layer of resin, or the like. An object of the second hoop wrapped layer is to achieve both effective and aesthetic encasement of the unit, in accordance with the present invention.

Preferably, coaxial or helical wrapping of the barrier tube is done, e.g., relatively tightly, and at about a 54 degree angle from an axially running center axis of the unit. Also, it is desired that axial or hoop wrapping of the adapter and filter unit is, in turn, done, for instance, also relatively tightly, at about a 90 degree angle from an axially running center axis of the unit. It is understood that other wrapping angles and/or methods may be utilized in any combination, giving consideration to the purpose for which the present invention is intended. In this connection, it is additionally understood that the thickness of each layer depends upon the expected operating pressure. For normal use, i.e., generally within a range of 400 and 600 psi, conventional thicknesses are considered suitable, giving consideration to the purpose for which the present invention is intended. It has been found that pressures up to about 2500 psi may be attained without failure of the encapsulated filtration unit at such layer thicknesses.

Generally speaking, the helical winding layer is intended to secure the unit from lateral expansion while keeping the adapter from moving in a longitudinal direction, i.e., axially of the permeate tube. Since helical windings are often prone to unraveling when axial fluid forces are applied during filter operation, the hoop winding layer is applied on top of the helical winding layer to substantially eliminate the possibility of longitudinal movement or shifting of the adapter and its components. Accordingly, the hoop winding prevents the helical winding from expanding and unraveling in the longitudinal direction, thereby maintaining the unit's strength and ability to withstand lateral expansion forces.

The resulting unit, in having end parts or members 36 at each end 37, 38 and the complete unit being encased in the second hoop wrapped layer 50, a substantially completely encapsulated membrane unit or element is formed. A unit of this general description is shown in FIG. 10. In one embodiment, the second hoop layer is comprised of a layer of glass fiber covered by a layer of molded resin, as generally provided herein, by conventional methods. More particularly, the layer is molded on the unit by selected winding of a resin-impregnated glass filament about the unit, the extent of such winding determining the thickness of the layer, in accordance with the desired filter requirements and operating pressure. After hardening, this composite layer forms a relatively rigid external surface or shell 33 on the filter body that is preferably cylindrical in shape. As presently contemplated, the encapsulated membrane unit or element (EME) is applied, e.g., in either 4 or 8 inch diameters.

It is noted that, according to various aspects of the present invention, the various parts and components of the present invention, though generally shown and described as having cylindrical and conical shapes, may be formed in any suitable shape and/or configured for use in any orientation, within the spirit and scope of the present invention. For instance, while the adapter is shown as having a tapered conical type shape, it is understood that a V-shape may also be suitable, giving consideration to the purpose for which the present invention is intended.

In addition, while the present invention has been described as having a shell formed by a layer of glass fiber covered by a layer of molded resin, those skilled in the art will appreciate that other materials of construction maybe appropriate, depending on system requirements such as the fluid being filtered and/or the system environment, giving consideration to the purpose for which the present invention is intended.

According to one embodiment of the present invention, two filter elements are connected to one another end to end via connecting elements so as to form a filter unit. Alternatively, the filter unit is formed using three filter elements connected to one another. According to a further alternative embodiment, the filter unit comprises a single filter element. Each end of the unit serves as both an inlet and an outlet, respectively, for receiving a flow of fluid, such ends each having an adapter 39 fit thereon. To facilitate such fit and interconnection of filter units, a slot or groove may optionally be provided on the periphery of the filter body and in the vicinity of each of its ends. This feature simplifies connection of filter heads to the filter unit for the intake and exhaust of fluid, an example of which is shown and described in co-pending U.S. patent application Ser. No. 09/994,488, filed on Nov. 24, 2001, entitled FILTER ASSEMBLY, SYSTEM AND METHOD FOR FILTERING FLUIDS, the disclosure of which is hereby incorporated by reference in its entirety.

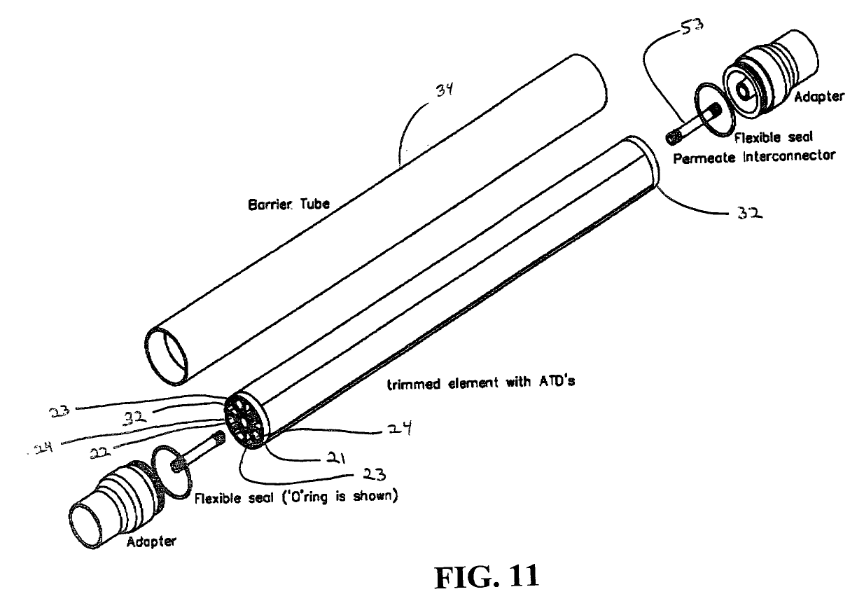

Desirably, each filter element is formed by spiral filter membrane, e.g., of a conventional type, wrapped around a tube in the form of a cylinder. The periphery of the cylinder is, in turn, wrapped in a tape so as to maintain the spiral membrane in a generally cylindrical shape. To this end, it is preferred that the connecting elements and end members each be constructed of a polymeric material. In addition, as set forth FIG. 11, each connecting element has an circular configuration comprising an annular exterior 21 with a hollowed central core or orifice 22 and spoke-like members 23 emanating radially from the walls of the core and radial openings 24 therebetween. With membrane type filters, according to the foregoing description, fluid preferably enters through one of the end members, as indicated by arrow F in FIG. 13, and exits in a filtered state through an axial tube 25 orifice of an end member at the opposite end. This is illustrated by arrow F′ in FIG. 13.

Although the present invention has been shown and described with membrane type filters, e.g., spiral membrane or microtube membrane filters, it is understood that any filter type or other device for physical and/or chemical separation may be utilized, within the spirit and scope of the present invention.

The connection of filter units to one another in series, in parallel or in any combination thereof is facilitated by the novel filter unit and construction provided, namely, the filter unit, filter elements, connecting elements, barrier tube, flexible connection and adapters, according to the present invention, and the ready adaptability afforded thereby. For instance, as illustrated above with reference to FIG. 13, each filter unit 20 comprises a series of filter elements 31, e.g., two, joined to one another end to end and coaxially by connecting elements 32, as described previously. Alternatively, each unit comprises three or four filter elements also joined to one another end to end and coaxially.

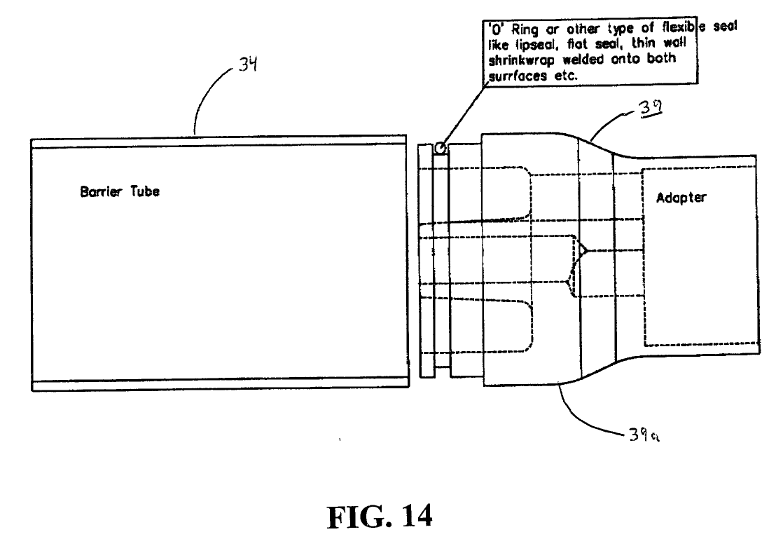

According to another aspect of the present invention, as best seen in FIG. 14, adapter 39 is preferably formed as a single part 39a and has slot 40 (or alternatively 44), and as shown in FIG. 11, has an axial duct 52 and mounts a permeate interconnector 53 having a relatively straight axial interior tube 54 or, optionally, offset interior tube. Fluid to be filtered desirably enters via the axial duct and exits via the axial tube. By way of a like adapter fit to the other end of the filter by one of its ducts, excess unfiltered fluid may exit the filter arrangement. Optionally, such adapter is also provided with an outlet duct, alternatively or concurrently therewith, for the exiting filtered fluid.

According to yet another embodiment, adapters according to the present invention may be configured for directly connecting one filter unit to another, as will be understood by those skilled in the art. An exemplary configuration, in accordance with this description, is provided in co-pending U.S. patent application Ser. No. 09/994,488, filed on Nov. 24, 2001. In this regard, one duct is desirably in a radial orientation for facilitating ready unit to unit connection. Using the filter units described, they may be assembled in series and/or in an array of units, depending on facility requirements and the plant so erected, as well as suitability of fluid entry and exit ducts.

While the present invention has been shown and described in connection with operations for water purification/filtration, it is understood that the invention may be applied to physical or chemical separation systems for any fluid including gases, liquids or the like, according to the purpose for which the present invention is intended.

Referring now to systems and applications, according to the present invention, a filtration facility or plant 50 may be constructed which has one or more components of the encapsulated filter unit type (a.k.a. a “Christmas Tree”) and provides for reversal of flow direction. An arrangement of this general description may be found, for instance, in co-pending U.S. patent application Ser. No. 09/994,488, filed on Nov. 24, 2001, entitled FILTER ASSEMBLY, SYSTEM AND METHOD FOR FILTERING FLUIDS.

Characteristically, as demonstrated by FIG. 1, the plant or operation has a first filtering phase in which a selected fluid is fed to a first filter unit, or alternatively a cluster or group of filter units. During the next or second phase of filtration, the fluid passes through a second filter unit, and/or cluster or group of filter assemblies, the number of units with the cluster depending upon system requirements. Finally, the fluid enters a third phase which is a third filter unit and/or third phase cluster of units. Next, the fluid is fed into the plant in an opposite direction, as an alternative or new path of flow.

Similarly, the filter unit of the present invention is considered applicable to a re-circulation circuit type filtration facility or plant, an example of which is also set forth in co-pending U.S. patent application Ser. No. 09/994,488, filed on Nov. 24, 2001. Such reversal of flow or flow inversion characteristic of such a facility has been found beneficial for minimizing bacterial growth as well as the accumulation of waste deposits and impurities on filter elements. This, in turn, prolongs the functional life of the filter membranes.

The encapsulated filter unit, according to various aspects of the present invention, is also believed suitable for use in a re-circulation circuit type filtration facility in combination with an arrangement for mixing flows. Such an arrangement permits mixing of the flow supplied to the plant from several different entry points. By allowing fluid to be introduced in a user-selected, regulated fashion, an operator may adjust the system for optimum balance of flow within the system. Moreover, by controlling both volumetric flow rate and velocity of flow in different filters of the plant, recovery of filtered fluid is maximized and effluent of extraordinary quality is produced. A system of this general description may also be found, for instance, co-pending U.S. patent application Ser. No. 09/994,488, filed on Nov. 24, 2001.

Although the present invention is shown and described as having membrane element filtration units with particular features, it is understood that other suitable units and connecting arrangements may be utilized, within the spirit and scope of the present invention. One such unit and arrangement is described, for example, in co-pending U.S. patent application Ser. No. 09/991,567, entitled MEMBRANE ELEMENT FILTRATION UNIT, filed Nov. 23, 2001 by Johannes A. Thomassen, the disclosure of which is hereby incorporated by reference herein in its entirety. Other arrangements may also be used, in whole or in part, according to the present invention, and are provided in co-pending U.S. patent application Ser. No. 09/994,488, filed on Nov. 24, 2001, entitled FILTER ASSEMBLY, SYSTEM AND METHOD FOR FILTERING FLUIDS, which is a continuation-in-part of co-pending application Ser. No. 09/934,023, filed on Aug. 21, 2001, entitled SYSTEM FOR FILTERING FLUIDS AND THE FILTER USED IN THE SYSTEM. The disclosure of Ser. No. 09/994,488 has been incorporated by referenced previously. The disclosure of Ser. No. 09/934,023 is also hereby incorporated by reference herein in its entirety.

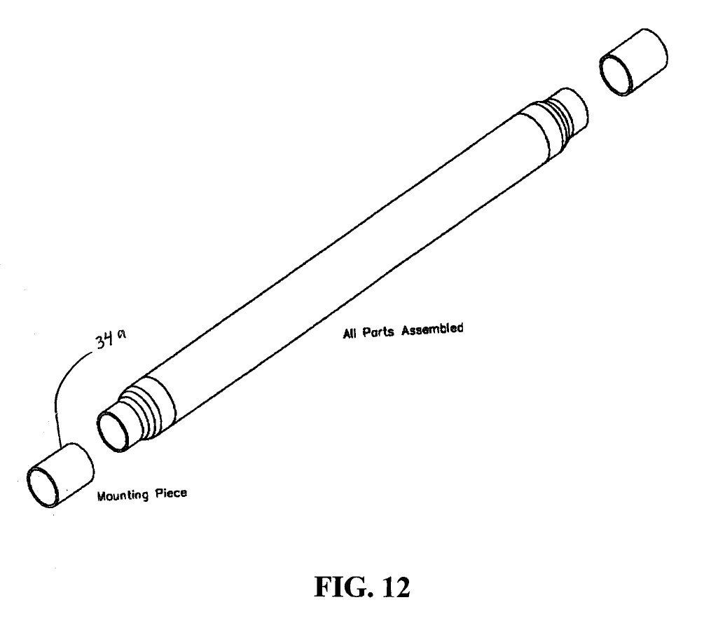

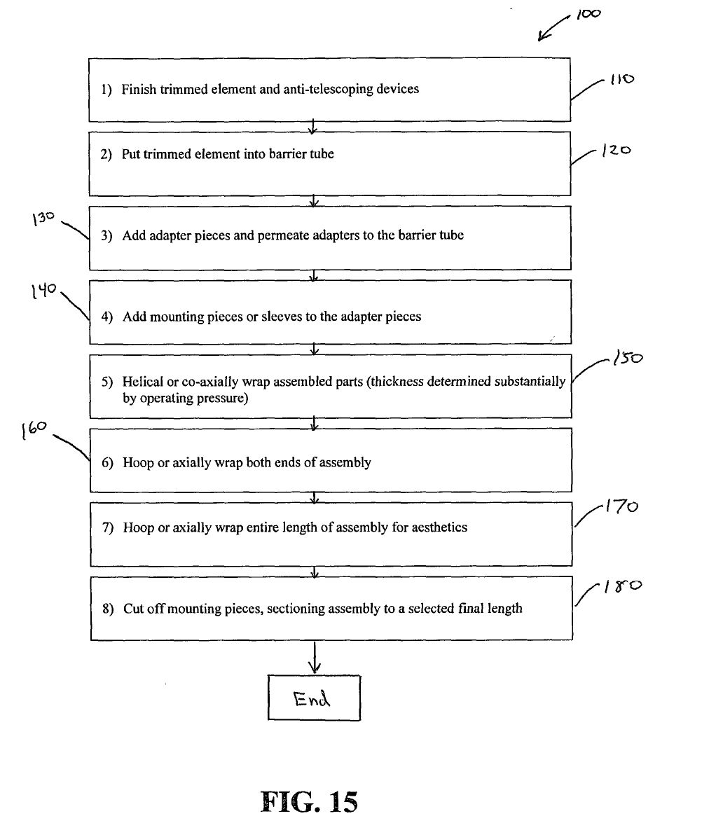

Turning now to another aspect of the present invention, as illustrated schematically in FIG. 15, a method 100 is provided for forming an encapsulated filtration unit, according to various aspects of the present invention. Initially, a trimmed or unwrapped membrane element is finished 110, the element having connecting elements at each end. Next, the trimmed element is located or positioned 120 inside a barrier tube. An adapter and a permeate interconnector are then inserted 130 into at least one end of the tube. As shown in FIG. 12, a mounting sleeve 34a, in turn, is inserted 140 into at least one of the adapters. Thereafter, the barrier tube is coaxially or helically wrapped 150 to a first selected thickness so as to encapsulate the tube, and each adapter is hoop wrapped 160 to a second selected thickness so as to encase the adapter. The mounting sleeve is separated or cut 170 from the adapters to form an encapsulated unit of a selected length, the respective helical and hoop wrappings abutting one another so as to substantially completely encapsulate the unit. Alternatively or concurrently, an additional step is performed, namely hoop wrapping 180 both the encapsulated tube and the encased adapter so as to effectively and aesthetically encapsulate the unit. Notably, this step may be performed either before or after cutting the mounting sleeves from the unit.

According to another aspect of the present invention, a method is provided for filtration of a fluid. First, a fluid flow is directed in a first direction, the fluid passing through a plurality of encapsulated filter units arranged in a generally parallel fashion relative to one another, each unit having a series of membrane filter elements linked by connecting elements and adapters. Next, the fluid flow in the first direction is ceased. Finally, the fluid flow is channeled in a direction opposite to that of the first direction, the fluid passing back through at least one of the plurality of encapsulated filter units so as to prevent bacterial growth as well as the accumulation of waste deposits and impurities on the filter assemblies.

In a further embodiment, a method for re-circulation filtration is described in which a plurality of encapsulated filter units are arranged in parallel for receiving a flow of fluid. Next, a fluid flow is channeled in a first direction so as to pass the fluid through at least one of the filter units. Finally, the fluid flow is passed in a reverse direction, back through the at least one filter unit so as to prevent bacterial growth as well as the accumulation of waste deposits and impurities on the filter assemblies.

Still another method, according to the present invention, is a process for re-circulation filtration and regulated flow mixing through a filter system. First, a plurality of encapsulated filter units are arranged in parallel to form a filter system for receiving a flow of fluid, each unit including a series of filter elements. A fluid flow is then directed in a first direction so as to pass the fluid through at least one of the filter units. Valves are positioned at selected points of the filter units to allow introduction and mixing of fluid flow supplied from several different entry points, and thereby allow a user to adjust the filter system for optimum balance of fluid flow.

Overall, the present invention advantageously provides a high performance filtration system with increased longevity filter elements and leak-free connections between filter components, regardless of operating pressure. Use of a barrier tube with a coaxial or helical wrap along the tube length and out to the mounting socket for the adapter provides superior handling of lateral forces of filter unit expansion experienced during filter operation. The additional application of a hoop wrap over conical portions of the adapter prevents co-axial unwinding of the helical wrap, thereby exhibiting extraordinary lateral force durability. The complete encapsulation afforded by these units also reduces bacterial contamination.

In this manner, the present invention not only provides for improved, multi-stage filtration but also allows for ready removal of filter components for replacement or maintenance. One or a plurality of filter units are optionally provided which are adapted for arrangement in series and/or parallel. This, in combination with an improved filter head/adapter arrangement, allows different filter units to be assembled into a filtration plant, simply and for optimum performance but at relatively low cost. Furthermore, this arrangement allows a membrane filter body to be used that is manufactured a relatively low cost. Providing a filtration systems with reversible flow direction, in combination with flow mixture regulation methods, it has been found, yields optimum cleaning of a fluid that minimizes bacterial growth on filter elements as well as build up of deposits and impurities. Other benefits of the encapsulated membrane filter unit include superior salt removal during fluid desalinization applications as well as enhanced purification in ultra and microfiltration applications.

The present invention presents a simple, practical and reliable filtration system with filter components that may be connected and arranged with external piping for optimum filtration. This filter arrangement also facilitates user-selected, custom assembly of a filtration plant, simply, effectively, economically and for optimum performance. In addition, the units are easily installed and/or replaced and have a simple, user friendly design, making the need for skilled labor to install or maintain them unnecessary.

With its superior effectiveness and simplicity, the present invention is considered well-suited to a variety of applications including, but not limited to, industrial and/or residential wastewater treatment, desalinization of sea water, membrane filtration, e.g., ultrafiltration, microfiltration, nanofiltration, reverse osmosis, or the like. Other benefits include the unit's ready suitability for disposal, as well as its adaptability to non-aqueous, non-industrial and even medical applications. For instance, units according to the present invention may be miniaturized proportionately for use in a hemodialysis system, in particular, for eliminating bacteria and toxins and preventing their accumulation in the system.

Various modifications and alterations to the present invention may be appreciated based on a review of this disclosure. These changes and additions are intended to be within the scope and spirit of this invention as defined by the following claims.

What is claimed is:

1. A system for filtering fluids, which comprises a plurality of encapsulated filter units, each unit including a generally cylindrically shaped, membrane filter body with a plurality of filter elements, an anti-telescoping connector element at each element end for joining the filter elements end to end and coaxially to one another, a relatively rigid outer shell for housing the joined elements, and a filter head at each end for enabling connection of the units to one another while capping the unit ends; the shell comprising a barrier tube encased by a helically wrapped layer of a first material, and each filter head including an adapter encapsulated by a hoop wrapped layer of second material, the respective layers abutting one another such that a continuous, generally uniform, relatively rigid composite outer wrapped layer formed for effectively encasing the unit, the adapter having a slot located on an interior peripheral surface for receiving a sealing member, whereupon engagement of the sealing member with the slot on one side and the barrier tube on the other side, a flexible seal between the adapter and barrier tube is effected during filter unit operation.

2. A system for filtering fluids, which comprises a plurality of encapsulated filter units, each unit including a generally cylindrically shaped, membrane filter body with a plurality of filter elements, an anti-telescoping connector element at each element end for joining the filter elements end to end and coaxially to one another, a relatively rigid outer shell for housing the joined elements, and a filter head at each end for enabling connection of the units to one another while capping the unit ends; the shell comprising a barrier tube encased by a helically wrapped layer of a first composite material, and each filter head including an adapter encapsulated by a hoop wrapped layer of second composite material, the respective layers abutting one another such that a continuous, generally uniform, relatively rigid composite outer wrapped layer formed for effectively encasing the unit, the adapter having a slot located on an interior peripheral surface for receiving a sealing member, whereupon engagement of the sealing member with the slot on one side and the connecting element on the other side, a flexible seal between the adapter and connector element is effected during filter unit operation.

3. A system for filtering fluids, which comprises:
a plurality of filter units, each unit including a generally cylindrically shaped, membrane filter body comprising a plurality of filter elements;
connecting elements for joining the filter elements end to end and coaxially to one another;
a relatively rigid barrier tube for housing the joined elements, the elements having peripheral portions configured for snug engagement within the outer shell;
an adapter engaged with each end of the barrier tube for joining the units to one another and capping the unit ends;
the adapter having a slot located on an interior peripheral surface for receiving a sealing member, whereupon engagement of the sealing member with the slot on one side and the barrier tube on the other side, a flexible seal between the adapter and the barrier tube is effected during filter unit operation;
the barrier tube being covered substantially over its length by a helically wrapped layer and the adapter being covered substantially over its length by a first hoop wrapped layer, the respective layers abutting one another such that a continuous, generally uniform, relatively rigid composite outer first wrapped layer; and
a second hoop wrapped layer of a third material formed about the first wrapped layer for effectively and aesthetically encasing the unit.

4. A system for filtering fluids, which comprises:
a generally cylindrically shaped, membrane filter body comprising a plurality of filter elements;
connecting elements for joining the filter elements end to end and coaxially to one another;
a relatively rigid barrier tube for housing the joined elements, the elements having peripheral portions configured for snug engagement within the outer shell;
an adapter engaged with each end of the barrier tube for joining the units to one another and capping the unit ends;
the adapter having a slot located on an interior peripheral surface for receiving a sealing member, whereupon engagement of the sealing member with the slot on one side and the connector element on the other side, a flexible seal between the adapter and the connector element is effected during filter unit operation;
the barrier tube being covered substantially over its length by a helically wrapped layer and the adapter being covered substantially over its length by a first hoop wrapped layer, the respective layers abutting one another such that a continuous, generally uniform, relatively rigid composite outer first wrapped layer; and
a second hoop wrapped layer formed about the first wrapped layer for effectively and aesthetically encasing the unit.

5. An encapsulated filter unit having a generally cylindrically shaped, membrane filter body with a plurality of filter elements, an anti-telescoping connector element at each element end for joining the filter elements end to end and coaxially to one another, a relatively rigid outer shell for housing the joined elements, and a filter head at each end for enabling connection of the units to one another while capping the unit ends; the shell comprising a barrier tube encased by a helically wrapped layer of a first material, and each filter head including an adapter encapsulated by a hoop wrapped layer of second material, the respective layers abutting one another such that a continuous, generally uniform, relatively rigid composite outer wrapped layer formed for effectively encasing the unit, the adapter having a slot located on an interior peripheral surface for receiving a sealing member, whereupon engagement of the sealing member with the slot on one side and the barrier tube on the other side, a flexible seal between the adapter and barrier tube is effected during filter unit operation.

6. The filter unit set forth in claim 5 wherein the filter element includes a spiral membrane.

7. The filter unit set forth in claim 5 wherein the filter element includes a microtube membrane.

8. The filter unit set forth in claim 5 wherein the first material of the helically wrapped layer comprises a selected glass fiber and molded resin.

9. The filter unit set forth in claim 5 wherein the second material of the hoop wrapped layer comprises a selected glass fiber and molded resin.

10. The filter unit set forth in claim 5 wherein the barrier tube is constructed, at least in part, of a selected polymeric material.

11. The filter unit set forth in claim 5 wherein the adapter is constructed, at least in part, of a selected polymeric material.

12. The filter unit set forth in claim 5 wherein the sealing member is an O-ring.

13. An encapsulated filter unit having a generally cylindrically shaped, membrane filter body with a plurality of filter elements, an anti-telescoping connector element at each element end for joining the filter elements end to end and coaxially to one another, a relatively rigid outer shell for housing the joined elements, and a filter head at each end for enabling connection of the units to one another while capping the unit ends; the shell comprising a barrier tube encased by a helically wrapped layer of a first composite material, and each filter head including an adapter encapsulated by a hoop wrapped layer of second composite material, the respective layers abutting one another such that a continuous, generally uniform, relatively rigid composite outer wrapped layer formed for effectively encasing the unit, the adapter having a slot located on an interior peripheral surface for receiving a sealing member, whereupon engagement of the sealing member with the slot on one side and the connecting element on the other side, a flexible seal between the adapter and connector element is effected during filter unit operation.

18. The filter unit set forth in claim 13 herein the barrier tube is constructed, at least in part, of a selected polymeric material.

19. The filter unit set forth in claim 13 wherein the adapter is constructed, at least in part, of a selected polymeric material.

20. The filter unit set forth in claim 13 wherein the sealing member is an O-ring.

21. A filter unit which includes:
a generally cylindrically shaped, membrane filter body comprising a plurality of filter elements;
connecting elements for joining the filter elements end to end and coaxially to one another;
a relatively rigid barrier tube for housing the joined elements, the elements having peripheral portions configured for snug engagement within the outer shell;
an adapter engaged with each end of the barrier tube for joining the units to one another and capping the unit ends;
the adapter having a slot located on an interior peripheral surface for receiving a sealing member, whereupon engagement of the sealing member with the slot on one side and the barrier tube on the other side, a flexible seal between the adapter and the barrier tube is effected during filter unit operation;
the barrier tube being covered substantially over its length by a helically wrapped layer and the adapter being covered substantially over its length by a first hoop wrapped layer, the respective layers abutting one another such that a continuous, generally uniform, relatively rigid composite outer first wrapped layer; and
a second hoop wrapped layer of a third material formed about the first wrapped layer for effectively and aesthetically encasing the unit.

22. A filter unit which includes:
a generally cylindrically shaped, membrane filter body comprising a plurality of filter elements;
connecting elements for joining the filter elements end to end and coaxially to one another;
a relatively rigid barrier tube for housing the joined elements, the elements having peripheral portions configured for snug engagement within the outer shell;
an adapter engaged with each end of the barrier tube for joining the units to one another and capping the unit ends;
the adapter having a slot located on an interior peripheral surface for receiving a sealing member, whereupon engagement of the sealing member with the slot on one side and the connector element on the other side, a flexible seal between the adapter and the connector element is effected during filter unit operation;
the barrier tube being covered substantially over its length by a helically wrapped layer and the adapter being covered substantially over its length by a first hoop wrapped layer, the respective layers abutting one another such that a continuous, generally uniform, relatively rigid composite outer first wrapped layer; and
a second hoop wrapped layer formed about the first wrapped layer for effectively and aesthetically encasing the unit.

23. A method of forming an encapsulated filtration unit, which comprises the steps of:
i. finishing a trimmed membrane element, the element having connector elements at each end;
ii. locating the trimmed membrane element of step i. in a barrier tube;
iii. inserting an adapter and a permeate interconnector into at least one end of the barrier tube of step ii.;
iv. inserting a mounting sleeve into at least one of the adapters of step iii.;
v. helically wrapping the barrier tube to a first selected thickness so as to encapsulate the tube;
vi. hoop wrapping each adapter to a second selected thickness so as to encase the adapter; and
vii. cutting off the mounting sleeves so as to form an encapsulated unit of a selected length.

24. The method set forth in claim 23 wherein the helical wrapping of the barrier tube in step v. is done at about a 54 degree angle from an axially running center axis of the unit.

25. The method set forth in claim 23 wherein the hoop wrapping of the adapter in step vi. is done at about a 90 degree angle from an axially running center axis of the unit.

26. A method of forming an encapsulated filtration unit, which comprises the steps of:
i. finishing a trimmed membrane element;
ii. locating the trimmed membrane element of step i. in a barrier tube;
iii. inserting an adapter and a permeate interconnector into at least one end of the barrier tube of step ii.;
iv. inserting a mounting sleeve into at least one of the adapters of step iii.;
v. helically wrapping the barrier tube to a first selected thickness so as to encapsulate the tube;
vi. hoop wrapping each adapter to a second selected thickness so as to encase the adapter;
vii. hoop wrapping the encapsulated tube of step v. and the encased adapter of step vi. so as to effectively and aesthetically encase the unit; and
viii. cutting off the mounting sleeves so as to form an encapsulated unit of a selected length.

27. A method for filtration of a fluid, the method comprising the steps of:
i. directing a fluid flow in a first direction, the fluid passing through a plurality of encapsulated filter units arranged in a generally parallel fashion to one another, each unit having a series of membrane filter elements linked by connecting elements and adapters;
ii. ceasing the fluid flow in the first direction;
iii. directing the fluid flow in a direction opposite to that of the first direction, the fluid passing back through at least one of the plurality of encapsulated filter units so as to prevent bacterial growth as well as the accumulation of waste deposits and impurities on the filter assemblies.
